(19) United States
(12) Patent Application Publication
(10) Pub. No.: US 2007/0270538 A1
(43) Pub. Date: Nov. 22, 2007

(54) Elastomeric compositions comprising butyl rubber and propylene polymers

(76) Inventors: Marc Stacey Somers, Longview, TX (US); Carol Ann Perkins, Kingsport, TN (US)

Correspondence Address: POLLY C. OWEN, P.O. BOX 511, KINGSPORT, TN, 37662-5075, US

(21) Appl. No.: 11/804,119

(22) Filed: May 17, 2007

Related U.S. Application Data
(60) Provisional application No. 60/801,743, filed on May 19, 2006.

(51) Int. Cl. C08K 3/04

(52) U.S. Cl. 524/496

(57) ABSTRACT

This invention relates to elastomeric compositions comprising at least one polymeric elastomer, at least one propylene polymer, and at least one curing agent. The elastomer compositions can optionally contain other rubbers, such as natural rubber and a variety of other ingredients. The compositions containing propylene polymers and copolymers can have better processability and lower compound viscosities and can show an improvement in at least one of the following properties: air permeability, tensile strength, elongation, tear strength, adhesion, dynamic performance, flex fatigue resistance, and cure characteristics. These elastomer compositions are believed to be useful for applications where elastomeric polymer is currently used, such as, tire inner liners for tubeless tires, tire inner tubes, and ball bladders to name a few.

This application claims priority to provisional application having Ser. No. 60/801,743 filed on May 19, 2006 entitled “Butyl Rubber Compositions Containing Propylene Polymers and Copolymers”.

### FIELD OF THE INVENTION

The invention relates to a curable elastomeric composition comprising at least one elastomeric polymer, at least one propylene polymer, and at least one curing agent.

The invention also relates to the process of making the curable elastomeric composition as well as the process of making a cured elastomeric composition; wherein the elastomeric polymer in the cured elastomeric composition is substantially cross-linked.

### BACKGROUND OF THE INVENTION

Butyl elastomer compositions find utility in many applications such as tire inner tubes, inner liners for tubeless tires, ball bladders, curing bladders, belts, hoses, seals, stoppers, adhesives, sealants, mastics, tapes and waterproofing membranes to name a few. Due to the large demand for these products, there is a need in the industry for elastomeric compositions with improved properties and/or processibility.

The inventive elastomeric compositions of the present invention that comprise propylene polymers can have better processability as evidenced by lower mixing energy requirements, lower compound drop temperatures, and lower Moonie viscosities. The inventive elastomeric compositions can show an improvement in at least one of the following properties: air permeability, tensile strength, elongation, tear strength, adhesion, dynamic performance, flex fatigue resistance, and cure characteristics.

### BRIEF SUMMARY OF THE INVENTION

In one embodiment of this invention, a curable elastomeric composition is provided comprising at least one elastomeric polymer, at least one propylene polymer, and at least one curing agent.

In another embodiment of this invention, a process is provided to produce a curable elastomeric composition. The process comprises contacting at least one elastomeric polymer, at least one propylene polymer, and at least one curing agent.

In another embodiment of the invention, a process is provided to produce a cured elastomeric composition comprising heating the curable elastomeric composition to produce a cured elastomeric composition; wherein said elastomeric polymer in said cured elastomeric composition is substantially cross-linked.

In yet another embodiment of the invention, a cured elastomeric composition is provided as well as articles comprising the cured elastomeric composition.

### DETAILED DESCRIPTION

The present invention may be understood more readily by reference to the following detailed description of preferred embodiments of the invention and the Examples included therein.

Before the present compounds, compositions, articles, and/or methods are disclosed and described, it is to be understood that this invention is not limited to specific synthetic methods, specific processes, or to particular apparatuses, as such may, of course, vary. It is also to be understood that the terminology used herein is for the purpose of describing particular embodiments only and is not intended to be limiting.

In this specification and in the claims, which follow, reference will be made to a number of terms which shall be defined to have the following meanings.

As used in the specification and the appended claims, the singular forms “a,” “an” and “the” include plural referents unless the context clearly dictates otherwise. Thus, for example, reference to a polymer includes one or more polymers.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C1 to C5 hydrocarbons”, is intended to specifically include and disclose C1 and C5 hydrocarbons as well as C2, C3, and C4 hydrocarbons.

“Optional” or “optionally” means that the subsequently described event or circumstance may or may not occur, and that the description includes instances where said event or circumstance occurs and instances where it does not. For example, the phrase “optionally heated” means that the material may or may not be heated and that such phrase includes both heated and unheated processes.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contain certain errors necessarily resulting from the standard deviation found in their respective testing measurements.

A curable elastomeric composition is provided comprising at least one elastomeric polymer, at least one propylene polymer, and at least one curing agent.

The elastomeric polymer is produced from a polymerization reaction of at least one monoolefin monomer and at least one multiolefin monomer. In one embodiment of the invention, the monoolefin can be an isoolefin, such as C₄ to C₇ isomonolefins monomers. Examples of C₄ to C₇ monolefins include, but are not limited to, isobutylene, 2-methyl-1-butene, 3-methyl-1-butene, 2-methyl-2-butene, 4-methyl-1-pentene, and mixtures thereof. Examples of multiolefin monomers include, but are not limited to, isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, and 1-vinyl-cyclohexadiene.

The elastomeric polymer can include, but is not limited to, butyl rubber, halogenated butyl rubber, star-branched versions of these rubbers, and brominated isobutylene-co-para-methystyrene (BIMSM) or blends thereof.

The term “butyl rubber” is used in the rubber industry to describe copolymers made from a polymerization reaction mixture having from about 70% to about 99.5% by weight of an isoolefin which has about 4 to about 7 carbon atoms, e.g., isobutylene, and about 30% to about 0.5% by weight of a conjugated multiolefin having from about 4 to about 14 carbon atoms. The resulting copolymers contain 85% to 99.5% by weight of combined isoolefin and about 0.5% to 15% by weight of combined multiolefin. The amount of combined multiolefin can also be from about 0.5% to about 10% by weight or about 0.5% to about 5% by weight. Suitable conjugated multiolefins include, but are not limited to, isoprene, butadiene, and dimethyl butadiene, piperylene.

Butyl rubber can be prepared in a slurry process using methyl chloride as a vehicle and a Friedel-Crafts catalyst as the polymerization initiator. The methyl chloride offers the advantage that AlCl₃, a relatively inexpensive Friedel-Crafts catalyst, is soluble in it as are the isobutylene and isoprene comonomers. Additionally, the butyl rubber is insoluble in the methyl chloride and precipitates out of solution. The polymerization is generally carried out at temperatures of about −100° C. to about 0° C. The preparation of butyl rubber is described in U.S. Pat. Nos. 2,356,128 and 2,356,129, which are incorporated herein by reference to the extent they do not contradict the statements contained herein.

Conventional high molecular weight butyl rubber can have a number average molecular weight of about 25,000 to about 500,000. Other ranges are from about 80,000 to about 300,000 or from about 100,000 to about 250,000. Low molecular weight butyl rubbers can also be utilized having number average molecular weights ranging from about 5,000 to about 25,000.

In one embodiment of the invention, the isoolefin is isobutylene, and the conjugated multiolefin is isoprene. Typically, the amount of isoprene is <5%.

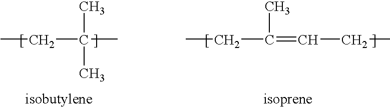

Isobutylene-isoprene rubber (IIR) is know for its low permeability to gases (excellent air retention), good flex properties, resistance to oxidation, ozone, ultra-violet light and heat (thermal stability) and its chemical and moisture resistance. Isobutylene/isoprene rubber is also known for its damping characteristics, which are related to its high hysteresis (i.e. no bounce). Isobutylene/isoprene rubber has a unique ability as an elastomer to dissipate energy as heat.

The elastomeric polymer can also be halogenated, particularly butyl rubber. These are known as halobutyls, halobutyl rubber, halo-isobutylene-isoprene rubber, or HIIR. More specifically, these are brominated or chlorinated isobutylene-isoprene rubbers, known as BIIR and CIIR respectively. Halobutyls have the general characteristics of isobutylene-isoprene rubber, but can be cured more rapidly than isobutylene-isoprene rubber and with different and smaller amounts of curative agents. Another advantage of halobutyl is that it can be co-cured (co-vulcanized) more readily than isobutylene-isoprene rubber with unsaturated polymers. Halobutyls also have good adhesion to themselves and other elastomers when they are cured in contact with one another. They are also known to have better heat resistance than isobutylene-isoprene rubber and permeability.

One method used to prepare halogenated butyl rubber is that of halogenating butyl rubber in a solution (butyl rubber cement) containing between about 1% to about 60% by weight of butyl rubber in a substantially inert C₅-C₈ hydrocarbon solvent, such as, pentane, hexane, heptane, and mixtures thereof and contacting this butyl rubber cement with a halogen for a period of up to about 25 minutes. There is then formed the halogenated butyl rubber and a hydrogen halide. The halogenated butyl rubber can contain up to one or more halogen atoms per double bond initially present in the butyl rubber.

In one embodiment of the invention, halogenated butyl rubber comprises a copolymer of 85% to 99.5% by weight of a C₄ to C₈ isoolefin with 15% to 0.5% by weight of a C₄ to C₁₄ multiolefin containing at least about 0.5% by weight combined halogen in its structure. For example, where butyl rubber is halogenated with bromine, the bromine can be present in the brominated butyl rubber in an amount ranging from about 1% to about 3% by weight. Another range is from about 1.5% to about 2.5% by weight. Methods of preparing halogenated buty rubber is described in U.S. Pat. No. 3,099,644, which is incorporated herein by reference to the extent it does not contradict any statements contained herein.

In addition to halogenated butyl rubber wherein a single halogen is incorporated into the elastomeric polymer structure, e.g. chlorine or bromine, more than one halogen can be incorporated e.g. both chlorine and bromine, to produce a bromochlorinated butyl rubber. One method of preparing such a product is to halogenate a solution of butyl rubber using bromine chloride as the halogenating agent.

The amount of the elastomeric polymer in the curable elastomeric composition can range from about 60 to about 100 phr. Other ranges for the amount of elastomeric polymer are from about 80 to about 100 phr and from about 90 to about 100 phr.

Optionally, the curable elastomeric composition can contain other; elastomeric materials, such as, but not limited to, natural rubber (NR), ethylene-propylene rubber (EPR), styrene-butadiene rubber (SBR), polybutylene rubber, and polychloroprene. The curable elastomeric composition can also contain other polymers, such as, but not limited to, isotactic polypropylene, low density polyethylene, styrene-isoprene-styrene block copolymers, and styrene-ethylene-butene-styrene (S-EB-S) block copolymers. The amount of these other elastomeric materials in the curable elastomeric composition ranges from 0 to about 40 phr. Other ranges are from 0 to about 20 phr and from 0 to about 10 phr. The amount of these other polymers in the curable elastomeric composition can range from 0 to about 40 phr. Other ranges are from 0 to about 20 phr and from 0 to about 10 phr.

The propylene polymers utilized in the elastomer compositions can be any propylene polymer that is known in the art. In one embodiment of the invention, the propylene polymers can be propylene homopolymers, propylene copolymers, terpolymers, interpolymers, and mixtures thereof. In another embodiment of the invention, the amount of propylene residues contained in the propylene copolymers, terpolymers, and interpolymers can be at least 50% by weight of the total propylene polymer. The propylene copolymers, terpolymers, and interpolymers of this invention are polymers containing propylene residues as well as residues from at least one alpha olefin selected from the group consisting of ethylene, 1-butene, 1-pentene, 1-hexene, 1-heptene, and 1-octene.

Propylene polymers have been described in detail in U.S. Pat. Nos. 5,041,251 and 6,100,351, herein incorporated by reference to the extent that it does not contradict the statements contained herein.

These propylene polymers have a relatively low viscosity and a low degree of crystallinity. In one embodiment the invention, the propylene polymers can have a Ring and Ball Softening Point between about 80° C. and about 160° C. according to ASTM E28. Other ranges are from about 80° C. to about 110° C., about 95° C. to about 120° C., about 115° C. to about 145° C., and about 140° C. to about 160° C. according to ASTM E28.

The propylene polymers can have a Brookfield Thermosel Viscosity between about 100 and about 100,000 centipoise (cP) at 190° C. according to ASTM D3236. Other ranges for the Brookfield Thermosel Viscosity of these propylene polymers are about 100 and about 75,000 centipoise; about 100 and about 50,000 centipoise, about 100 and about 25,000 centipoise, about 100 and about 20,000 centipoise, about 100 and about 15,000 centipoise, about 100 and about 10,000 centipoise, and about 100 and about 5,000 centipoise at 190° C. according to ASTM D3236.

Generally, propylene polymers can have a glass transition temperature (Tg) below 0° C. according to ASTM D3418. In another embodiment of the invention, the glass transition temperature of the propylene polymers can be less than −5° C., less than −10° C., or less than −15° C. In another embodiment of the invention, the propylene polymers can have no peak melting temperature (Tm) by ASTM D3418. In yet another embodiment of the invention, the propylene polymers can have a heat energy required to melt (Delta H_{f}) of less than 50 Joules per gram (both measured according to ASTM D3418).

These propylene polymers can further be described as having a needle penetration range of about 5 to about 300 dmm, determined by ASTM D5 (test method modified to 23° C., instead of 25° C.). These propylene polymers can have a needle penetration of about 5 to about 200 dmm at 23° C., or from about 5 to about 150 dmm at 23° C., or from about 5 to about 100 at 23° C., or from about 5 to about 75 dmm at 23° C., or from about 5 to about 50 dmm at 23° C., or from about 5 to about 25 dmm at 23° C.

Such propylene polymers are disclosed in U.S. Pat. No. 3,954,697 and U.S. Pat. No. 3,923,758; the disclosures of which are incorporated herein by reference in their entirety to the extent they do not contradict statements contained in this disclosure.

In one embodiment of the invention, the propylene polymers can be produced by polymerizing alpha olefin feedstocks using an anionic coordination catalyst in a pressurized vessel at elevated temperatures. Hydrogen may be metered in to control molecular weight of the polyolefin.

Propylene homopolymers, propylene-ethylene copolymers, and blends thereof can be obtained as Eastoflex® propylene polymers from Eastman Chemical Company.

Functionalized propylene polymers can also be utilized in this invention. Any functionalized propylene polymer known in the art can be utilized. In one embodiment of the invention, chlorine, maleic anhydride, and silane are utilized as functionalizing agents.

The amount of propylene polymers contained in the curable elastomeric composition can range from about 1 to about 20 phr. Other ranges of the amount of propylene polymer in the curable elastomeric composition are about 1 to about 15 phr and about 1 to about 10 phr.

The curable elastomeric composition also contains at least one curing agent. Vulcanization, or curing of the elastomer composition, is a physiochemical change resulting from crosslinking of the unsaturated hydrocarbon chain of a multiolefin (e.g. isoprene) with the aid of a curing agent, usually with application of heat. Vulcanization or curing has the effect of converting elastomeric polymers from a soft, tacky, thermoplastic to a strong, temperature-stable thermoset.

Any curing system known in the art that is compatible with the elastomeric polymer can be utilized. For further reference, see, chapter 2, “The Compounding and Vulcanization of Rubber, of “Rubber Technology”, 3^{rd} edition, published by Chapman and Hall, 1995, the disclosure of which is incorporated by reference to the extent it does not contradict any statements herein.

Activators, accelerators, and other additives can be added with the curing agent to facilitate curing. Curing agents include, but are not limited to, sulfur, sulfur-containing compounds, and non-sulfur containing compounds. Non-sulfur containing compounds include, but are not limited to, peroxides; metallic oxides, chlorinated quinones, or nitrobenzenes.

Examples of such sulfur and sulfur-containing compounds include, but are not limited to, sulfur, sulfenamide derivatives, mercaptobenzothazyl disulfide, benzothiazyl disulfide, n-t-butyl-2-benzothiazolesulfenamide, N-oxydiethylene benzothiazole-2-sulfenamide, 2-mercaptobenzothiazole, tetramethylthiuram disulfide, alkyl phenol disulfide, M-phenylene his-maleimide, zinc o-di-n-butylphosphorodithioate, zinc dibenzyldithiocarbamate, n-cyclohexyl-2-benzothiazole sulphenamide, isopropyl xanthate detrasulfide, zinc isopropyl xanthate, 1,3-dibutylthiourea, and 2-mercapto-4,5-methyl-benzimidazole.

Peroxide curing agents can include both organic and inorganic peroxides. Examples of organic peroxides include, but are not limited to dialkylperoxides, ketalperoxides, aralkylperoxides, peroxide ethers, peroxide esters, such as, di-tert-butylperoxide, bis-(tert-butylperoxyisopropyl)-benzene, dicumylperoxide, 2,5-dimethyl-2,5-di(tert-butylperoxy)-hexane, 2,5-dimethyl-2,5-di(tert-butylperoxy)-hexene-(3), 1,1-bis-(tert-butylperoxy)-3,3,5-trimethyl-cyclohexane, benzoylperoxide, and tert-butylcumylperoxide.

Activators can be added with curing agents to facilitate curing. Examples of activators include, but are not limited to, metal oxides, such as zinc oxide, and fatty acids, such as stearic acid. Accelerators can also be added to facilitate curing. Accelerators include, but are not limited to, aldehyde amines, dithiocarbamates, guanidines, sulfenamides, thiazoles, thioureas, thiurams, and other specialty compounds.

Examples of dithiocarbamates include, but are not limited to, bismuth dimethyl dithiocarbamate, zinc dibutyl dithiocarbamate, zinc diethyl dithiocarbamate, zinc dimethyl dithiocarbamate, copper dimethyl dithiocarbamate, N,N dimethyl cyclohexyl ammonium dithiocarbamate, tellurium diethyl dithiocarbamate, zinc dibenzyl dithiocarbamate, zinc pentamethylene dithiocarbamate, and zinc dibutyl dithiocarbamate dibutylamine complex.

Examples of guanidines include, but are not limited to, diortho tolyl guanidine and diphenyl guanidine. Examples of sulfenamides include, but are not limited to, N-T-butyl benzothiazole sulfenamide, N-cyclohexyl benxothiazole sulfenamide, 90% N-oxydiethylene benzothiazole sulfenamide, and thiocarbamyl sulfenamide. Examples of thiazoles include, but are not limited to, 2-mercaptobenzothiazole, benzothiazyl disulfide, and zinc mercaptobenzothiazole. Examples of thioureas include, but are not limited to, N,N′diethyl thiourea, ethylene thiourea, and N,N′-diphenylthiourea. Examples of thiurams include, but are not limited to, dipentamethylene thiuram treta/hexasulfide, tetrazylthiuram disulfide, tetraethyl thiuram disulfide, tetramethyl thiuram disulfide, tetramethyl thiuram monosulfide, tetramethyl/ethyl thiuram disulfide, N,N,N′,N′-tetraisobutylthiuram monosulfide, and N,N,N′,N′-tetraisobutylthiuram disulfide. Specialty type accelerators include, but are not limited to, 4,4′dithiodimorpholine, zinc salt of dibutyl phosphorodithiate, and zinc iso-propylxanthate.

The amount of curing agent is that which is sufficient to obtain the crosslinking required for the particular application of the cured elastomeric polymer. The amount of curing agent can range from 0.1 to about 25 phr. Other ranges are from 0.1 to 20 phr, 0.1 to 15 phr, 0.1 to 10 phr, and 0.1 to 5 phr. In one embodiment of the invention, the amount of curing agent is that which is sufficient to give a cure of greater than 90% as shown by a 90% S Prime value utilizing the MDR test as defined in the Examples Section of this disclosure. In other embodiments of the invention, a cure of the elastomeric polymer can be greater than 95% cure, greater than 99%, or greater than 100%.

Tackifier resins can be included in the curable elastomeric composition. Any tackifier known in the art can be utilized depending on the application of the cured elastomeric composition. Examples of such tackifier resins include, but are not limited to, aliphatic hydrocarbon resins, aromatic hydrocarbon resins, mixed aromatic/aliphatic hydrocarbon resins, phenolic resins, polyterpene resins, and rosin esters. Examples of aliphatic hydrocarbon resins include, but are not limited to, C₅ tackifier resins, such as Piccotac C₅ tackifier resins obtained from Eastman Chemical Company. Examples of rosin esters are pentaerythritol modified rosin esters commercially available as Pentalyn rosin ester from Eastman Chemical Company.

The amount of tackifier contained in the curable elastomeric composition can range from about 0 to about 20 phr. Other ranges are from 0 to about 15 phr, 0 to about 10 phr, and 0 to about 5 phr.

Plasticizers, mineral oils, or paraffinic and napthenic oils can be added to the curable elastomeric composition. Plasticizers and oils are utilized to assist in processing of the curable elastomeric composition. The amount of plasticizers and/or oils utilized can range from 0 to about 20 phr, from 0 to about 15 phr, from 0 to about 10 phr, and from 0 to about 5 phr.

Other additives to the curable elastomeric composition can include, but are not limited to, reaction accelerators, vulcanizing acceleration auxiliaries, reinforcers, lubricants, crosslinking agents, dispersing agents, inorganic fillers, colorants, dyes, antioxidants, foaming agents, anti-aging agents, heat stabilizers, light stabilizers, ozone stabilizers, processing aids, blowing agents dyestuffs, pigments, waxes, extenders, and organic acids.

Inorganic fillers can include, but are not limited to, silica; silicates, such as aluminum silicate, magnesium silicate, or calcium silicate; glass fibers; metal oxides, such as, zinc oxide, calcium oxide, magnesium oxide, and aluminum oxide; metal carbonates, such as magnesium carbonate, calcium carbonate, and zinc carbonate; metal hydroxides, such as aluminum hydroxide and magnesium hydroxide; carbon blacks, such as SAF, ISAF, HAF, FEF, or GPF carbon blacks; clays, such as, nanoclay, bentonite, gypsum, alumina, titanium dioxide, and talc; rubber gels, such as, those based on polybutadiene, butadiene/styrene copolymers, butadiene/acrylonitrile copolymers and polychloroprene.

The curable elastomeric composition can be prepared by any method known in the art. In one embodiment of the invention, the elastomeric polymer, propylene polymer, and curing agent are mixed in any suitable mixing device, such as, a two-roll mill, an internal mixer, a Banbury Mixer, a kneader, or similar mixing device. Blending temperatures can range from about 15° C. to about 180° C. Blending times can vary from about 4 to about 10 minutes.

The cured elastomeric composition can be prepared by any method known in the art. In one embodiment, the curable elastomeric composition is cured by heating. The curing temperature and duration of curing are generally selected based on the curing agent, the activator, and the accelerator selected. Generally, the cure time is inversely proportional to the cure temperature. In one embodiment of the invention, the curable elastomeric composition is cured by heating to a temperature in the range of about 100° C. to about 260° C. Other temperature ranges are from about 140° C. to about 225° C. and about 150° C. to about 205° C. Curing of elastomeric polymer compositions are disclosed in U.S. Pat. Nos. 3,031,423 and 4,587,302, which are hereby incorporated by reference to the extent they do not contradict the statements herein.

In one embodiment of the invention, the elastomeric polymer, propylene polymer, and any additional component, excluding the curing agent, are mixed in a suitable mixing device at a temperature ranging from about 45° C. to about 180° C. to form a homogeneous melt. Then, at least one curing agent and optionally, at least one activator, and optionally, at least one accelerator, are added. The curable elastomeric composition is then heated to produce the cured elastomeric composition.

These cured elastomeric compositions can be of use in components in tire construction, such as, but not limited to, tire inner tubes, tire inner liners, tire sidewalls, tire cover strips, tire curing bladders, tire curing envelopes (for curing pre-vulcanized treads for re-treading tires). Other uses for these cured elastomeric compositions include, but are not limited to, rubber edges for audio speakers, engine and transmission mounts, automotive exhaust hangers, window strips, asphalt roofing materials, waterproofing membranes for roofing and pond liners, condenser packing for electrical appliances, conveyor belts, linings (e.g. for tanks/vessels/pipes), chewing gum, pharmaceutical rubber products (such as closures for pharmaceutical packaging), biomedical devices, protective clothing and equipment, ball bladders, rubber hoses and seals, rubber stoppers, contact cement, sealants, sealant tapes, adhesives, adhesives for tapes, transparent tapes, hot melt pressure sensitive adhesives, mastics (e.g. for pipe wrap), vinyl floor tile adhesives, semi-conducting electrical splicing tape, gaskets, and various, molded articles.

### EXAMPLES

The following ASTM test methods were utilized to produce the data contained in the Examples section of this disclosure.

Adhesive Strength (kN/M) data was obtained using ASTM 395 Method B.

Brittle Point data was obtained using ASTM D2137

DeMattia Flex Test (Crack Growth Aged) data was obtained using ASTM D813.

MDR Cure Characteristics—ASTM D 5289

Mooney Viscosity & Scorch'ASTM D1646

Rubber Adhesion data was obtained using ASTM 429.

Shore A Hardness data were obtained using ASTM D2240.

Stress Strain (dumbells)(MPa) data were obtained using ASTM D412, and Stress Strain (hot air oven) data was obtain using ASTM D573.

Tear Strength (kN/m) data were obtained using ASTM D624 (Die C).

Ultimate Tensile (MPa), and Ultimate Elongation (%) data were obtained using ASTM D412.

To obtain permeability data, ASTM D1434 for measuring permeability of a plastic film to air was amended for analysis of elastomer compositions. Positive gas pressure was applied to one side of the specimen that consisted of a thin vulcanized sheet of the elastomer composition. The air permeating the sheet displaced a liquid from a graduated capillary tube, permitting a direct measurement of the volume. Test conditions were at 65.6° C. at 0.345 MPa (50 psig). Conditioning of the sample in the apparatus under pressure was conducted for 16 hours at a temperature of 23° C. prior to obtaining data.

To obtain GABO Performance Properties the following test was utilized. Dynamic testing for vulcanized compounds measures their viscoelastic behavior as a function of stress, strain, frequency, temperature, and time. This data can be utilized to locate transition temperatures, characterize the structure, and evaluate material performance in various applications. In this test, a small sinusoidal deformation is imposed on the test specimen throughout a range of temperatures or frequencies. The resulting stress and the phase difference between the imposed deformation and the response are measured. A GABO Elpexor was utilized with liquid nitrogen as the reagent. Samples of the elastomer composition was cut utilizing a GABO die.

### Example 1

### Formulations of Elastomer Compositions

Table 1 contains the formulations of the elastomer compositions. All values are given as parts per hundred rubber (phr). The control formulations in these examples were intended to represent a possible tire inner liner formulation. Comparative Example 1 is a 100 phr brominated isobutylene-isoprene rubber control, and Comparative Example 2 is a 90 phr brominated isobutylene-isoprene rubber/10 phr natural rubber control. The 100 phr brominated isobutylene-isoprene rubber control formulation was supplied to Eastman Chemical Company by Lanxess Inc. located in Ontario, Canada.

The elastomer compositions for the inventive examples were produced by the following process. First, the rubber compound or compounds were mixed for 30 seconds in a 1,602 gram Banbury mixer with temperatures set at 30 C, a ram pressure of 30 psig and a rotor speed of 77 rpm. Then, the propylene polymer, tackifier resin, oil, and carbon black were added. Optionally, nanoclay was also added in some of the examples. After 3.5 minutes of mixing, the ram was raised to conduct a sweep, where the carbon balck was swept off the ram arm and upper part of the mixer. The ram was lowered and mixing was resumed. After 5 minutes, the elastomer composition was removed from the Banbury mixer and weighed to ensure that all of the elastomer composition had been removed from the mixer. The elastomer composition was then transferred to a two-rool mill (10 inch diameter×20 inch length rolls) with a 2000 gram capacity where the curing agents were added. The elastomer composition was refined using several cuts/folds, then passed endwise through the mill 6 times.

TABLE 1

| | Example Number | | | | | | | | | | | |
|---|---|---|---|---|---|---|---|---|---|---|---|---|
| | Comp. 1 | Comp. 2 | Inv. 1 | Inv. 2 | Inv. 3 | Inv. 4 | Inv. 5 | Inv. 6 | Inv. 7 | Inv. 8 | Inv. 9 | Inv. 10 |
| LANXESS | 100 | 90 | 95 | 95 | 95 | 100 | 100 | 100 | 100 | 100 | 100 | 90 |
| BROMOBUTYL | | | | | | | | | | | | |
| 2030 | | | | | | | | | | | | |
| SMR 10 | — | 10 | 5 | 5 | 5 | 0 | 0 | 0 | 0 | 0 | — | 10 |
| NATURAL | | | | | | | | | | | | |
| RUBBER | | | | | | | | | | | | |
| CARBON | 60 | 60 | 60 | 60 | 60 | 60 | 60 | 60 | 60 | 60 | 60 | 48 |
| BLACK N 660 | | | | | | | | | | | | |
| STERLING-V | | | | | | | | | | | | |
| EASTOFLEX | — | — | 5 | — | — | 10 | — | — | — | 6 | 7.5 | — |
| APO P1023PL-1 | | | | | | | | | | | | |
| (J-14156) | | | | | | | | | | | | |
| EASTOFLEX | — | — | — | 5 | — | — | 10 | — | 6 | — | 2.5 | — |
| APO E1060PL-1 | | | | | | | | | | | | |
| (J-14155) | | | | | | | | | | | | |
| EASTOFLEX | — | — | — | — | 5 | — | — | 10 | 4 | 4 | — | — |
| APO E1200 (J- | | | | | | | | | | | | |
| 14157) | | | | | | | | | | | | |
| CLOISITE 15A | — | — | — | — | — | — | — | — | — | — | — | 8 |
| PENTALYN A | 4 | 4 | 4 | 4 | 4 | 4 | 4 | 4 | 4 | 4 | 4 | 4 |
| PICCOTAC 1100 | — | — | — | — | — | — | — | — | — | — | — | — |
| (J-14159) | | | | | | | | | | | | |
| STEARIC ACID | 1 | 1 | 1 | 1 | 1 | 1 | 1 | 1 | 1 | 1 | 1 | 1 |
| (TRIPLE | | | | | | | | | | | | |
| PRESSED) | | | | | | | | | | | | |
| SUNPAR 2280 | 7 | 7 | 5 | 5 | 5 | 2 | 2 | 2 | 2 | 2 | 2 | 2 |
| SULFUR NBS | 0.5 | 0.5 | 0.5 | 0.5 | 0.5 | 0.5 | 0.5 | 0.5 | 0.5 | 0.5 | 0.5 | 0.5 |
| VULKACIT | 1.3 | 1.3 | 1.3 | 1.3 | 1.3 | 1.3 | 1.3 | 1.3 | 1.3 | 1.3 | 1.3 | 1.3 |
| DM/C (MBTS) | | | | | | | | | | | | |
| ZINC OXIDE | 3 | 3 | 3 | 3 | 3 | 3 | 3 | 3 | 3 | 3 | 3 | 3 |
| (KADOX 920) | | | | | | | | | | | | |
| GRADE PC 216 | | | | | | | | | | | | |

Bromobutyl Rubber 2030 was obtained from Lanxess Inc. in Ontario Canada.
SMR 10 Natural Rubber is a standard Malaysian Rubber product.
Carbon Black N 660 was obtained from Cabot Corporation.
Eastoflex Propylene polymer P1023PL-1, E1060PL-1, and E1200 were obtained from Eastman Chemical Company.
Cloisite 15A is a nanoclay obtained from Southern Clay Products, Inc. located in Gonzales, TX.
Pentalyn A is a tackifier resin obtained from Eastman Chemical Company.
Stearic Acid (Triple Pressed) is an activator
Sunpar 2280 oil was obtained from Sunoco located in Philadelphia, PA.
Sulfur NBS as a curing agent
Vulkacit DM/C (dibenzothiazyl disulfide (MTBS) - accelerator obtained from Lanxess Inc. in Ontario Canada
Zinc Oxide (Kadox 920)Grade PC216 - is an activator obtained from Horsehead Corporation.

### Example 2

This example shows the tensile, elongation, and hardness properties of the elastomer compositions. Each elastomer composition was formulated to have approximately the same Shore A Hardness by adjusting ingredient levels. The properties of compounds with similar Shore A Hardness can be directly comparable.

TABLE 2

| | Example Number | | | | | |
|---|---|---|---|---|---|---|
| Initial Physical Properties | Comp. 1 | Comp. 2 | Inventive 1 | Inventive 3 | Inventive 6 | Inventive 8 |
| Dumbell | die C | die C | die C | die C | die C | die C |
| Test Temperature (° C.) | 23 | 23 | 23 | 23 | 23 | 23 |
| Hardness Shore A2 (pts.) | 51 | 51 | 52 | 52 | 53 | 50 |
| Ultimate Tensile (MPa) | 9.62 | 9.85 | 9.67 | 9.63 | 9.23 | 9.29 |
| Ultimate Elongation (%) | 788 | 691 | 745 | 768 | 779 | 729 |
| Stress @ 25 (MPa) | 0.697 | 0.718 | 0.733 | 0.733 | 0.717 | 0.767 |
| Stress @ 50 (MPa) | 0.806 | 0.908 | 0.898 | 0.876 | 0.839 | 0.907 |
| Stress @ 100 (MPa) | 1.08 | 1.35 | 1.24 | 1.2 | 1.11 | 1.23 |
| Stress @ 200 (MPa) | 2.01 | 2.64 | 2.35 | 2.25 | 2.03 | 2.33 |
| Stress @ 300 (MPa) | 3.31 | 4.36 | 3.85 | 3.68 | 3.33 | 3.81 |

The data in Inventive Examples 1, 3, 6, and 8 show that all elastomer compositions containing the propylene polymer, propylene copolymer, or combinations thereof have better elongation than Comparative Example 2 which contains 90 phr brominated isobutylene/isoprene rubber and 10 phr natural rubber. Tensile properties of compounds containing propylene polymer, propylene copolymer, or combinations thereof are roughly the same or slightly lower than Comparative Example 1 containing 100 phr brominated isobutylene/isoprene rubber, while the elongated stress values are higher.

### Example 3

This example shows the impact of heat aging the cured rubber samples at 121-125° C. for 72 hours.

TABLE 3

| Heat Aging Performance | Example Number | | | | | |
|---|---|---|---|---|---|---|
| (Hot Air Oven) | Comp. 1 | Comp. 2 | Inventive 1 | Inventive 3 | Inventive 6 | Inventive 8 |
| Test Temperature (° C.) | 23 | 23 | 23 | 23 | 23 | 23 |
| Ageing Time (hrs) | 72 | 72 | 72 | 72 | 72 | 72 |
| Ageing Temperature (° C.) | 125 | 121 | 121 | 121 | 121 | 121 |
| Ageing Type | air oven | air oven | air oven | air oven | air oven | air oven |
| Hardness Shore A2 (pts.) | 57 | 59 | 60 | 58 | 59 | 57 |
| Ultimate Tensile (MPa) | 9.52 | 9.79 | 9.78 | 9.87 | 9.84 | 9.35 |
| Ultimate Elongation (%) | 626 | 527 | 591 | 581 | 615 | 630 |
| Stress @ 25 (MPa) | 0.929 | 1.05 | 1.03 | 1.08 | 1.01 | 0.962 |
| Stress @ 50 (MPa) | 1.16 | 1.4 | 1.32 | 1.33 | 1.31 | 1.25 |
| Stress @ 100 (MPa) | 1.82 | 2.17 | 1.94 | 1.96 | 2.11 | 1.97 |
| Stress @ 200 (MPa) | 3.76 | 4.23 | 3.68 | 3.71 | 4.32 | 3.99 |
| Stress @ 300 (MPa) | 5.67 | 6.36 | 5.6 | 5.71 | 6.26 | 6.03 |
| Chg. Hard. Shore A2 (pts.) | 6 | 8 | 8 | 6 | 6 | 7 |
| Chg. Ulti. Tens. (%) | −1 | −1 | 1 | 2 | 7 | 1 |
| Chg. Ulti. Elong. (%) | −21 | −24 | −21 | −24 | −21 | −14 |
| Change Stress @ 25 (%) | 33 | 46 | 41 | 47 | 41 | 25 |
| Change Stress @ 50 (%) | 44 | 54 | 47 | 52 | 56 | 38 |

The data in Inventive Examples 1, 3, 6, and 8 show that all elastomer compositions containing propylene polymer, propylene copolymer, or combinations thereof (rough 8A) had a slight increase in aged tensile properties in comparison to the control formulations in Comparative Examples 1 and 2. Other aged properties of the elastomer compositions containing propylene polymer, propylene copolymer, or combinations thereof have similar results to the control formulations in reference to the change in aged properties from the original values.

### Example 4

This example shows how tear strength of a butyl rubber compound can be increased by adding an propylene polymer, propylene copolymer, or combinations thereof. The data are contained in Table 4.

TABLE 4

| | | Inven- | Inven- | Inven- | Inven- | Inven- |
|---|---|---|---|---|---|---|
| | Comp. | tive | tive | tive | tive | tive |
| DIE C TEAR | 2 | 1 | 3 | 4 | 6 | 8 |
| Cure Time | 13 | 12 | 13 | 16 | 15 | 18 |
| (min) | | | | | | |
| Cure | 166 | 166 | 166 | 166 | 166 | 166 |
| Temperature | | | | | | |
| (° C.) | | | | | | |
| Test | 23 | 23 | 23 | 23 | 23 | 23 |
| Temperature | | | | | | |
| (° C.) | | | | | | |
| Tear Strength | 36.0 | 36.3 | 36.6 | 37.9 | 37.7 | 37.4 |
| (kN/m) | | | | | | |

Comparative Example 2 is a 90 phr butylated isobutylene/isoprene rubber/10 phr natural rubber control composition. The data show that by replacing 5 phr natural rubber with 5 phr of an propylene polymer (Inventive Example 1) or an propylene copolymer (Inventive Example 3) and slightly reducing the amount of oil, that the tear strength can be slightly increased. In Inventive Examples 4, 6, and 8, all of the 10 phr of the natural rubber was replaced with 10 phr of the propylene polymer, propylene copolymer or a combination thereof along with oil reduction. These blends had even higher tear strengths than the elastomer compositions containing 5 phr propylene polymer, propylene copolymer, or combinations thereof.

### Example 5

This example shows the impact of heat aging the cured rubber samples at 121° C. for 168 hours. The data are shown in Table 5.

TABLE 5

| STRESS STRAIN (HOT AIR OVEN) | Comp. 2 | Inventive 1 | Inventive 3 | Inventive 6 | Inventive 8 |
|---|---|---|---|---|---|
| Test Temperature (° C.) | 23 | 23 | 23 | 23 | 23 |
| Ageing Time (hrs) | 168 | 168 | 168 | 168 | 168 |
| Ageing Temperature (° C.) | 121 | 121 | 121 | 121 | 121 |
| Ageing Type | air oven | air oven | air oven | air oven | air oven |
| Hardness Shore A2 (pts.) | 64 | 62 | 65 | 60 | 58 |
| Ultimate Tensile (MPa) | 8.94 | 9.68 | 9.53 | 9.14 | 9.02 |
| Ultimate Elongation (%) | 398 | 492 | 492 | 547 | 604 |
| Stress @ 25 (MPa) | 1.33 | 1.24 | 1.29 | 1.04 | 0.952 |
| Stress @ 50 (MPa) | 1.76 | 1.57 | 1.65 | 1.4 | 1.26 |
| Stress @ 100 (MPa) | 2.73 | 2.3 | 2.49 | 2.34 | 1.97 |
| Stress @ 200 (MPa) | 4.94 | 4.32 | 4.58 | 4.64 | 4.02 |
| Stress @ 300 (MPa) | 7.23 | 6.57 | 6.79 | 6.46 | 5.91 |
| Chg. Hard. Shore A2 (pts.) | 13 | 10 | 13 | 7 | 8 |
| Chg. Ulti. Tens. (%) | −9 | 0 | −1 | −1 | −3 |
| Chg. Ulti. Elong. (%) | −42 | −34 | −36 | −30 | −17 |
| Change Stress @ 25 (%) | 85 | 69 | 76 | 45 | 24 |
| Change Stress @ 50 (%) | 94 | 75 | 88 | 67 | 39 |
| Change Stress @ 100 (%) | 102 | 85 | 108 | 111 | 60 |
| Change Stress @ 200 (%) | 87 | 84 | 104 | 129 | 73 |
| Change Stress @ 300 (%) | 66 | 71 | 85 | 94 | 55 |

The data show that all of the elastomer compositions containing propylene polymer, propylene copolymer, or combinations thereof (Inventive Examples 1, 3, 6, and 8) had higher aged tensile and elongation properties, less of a change in Shore A hardness, and similar or smaller changes in aged stress values in comparison to Comparative Example 2 containing 10 phr natural rubber.

### Example 6

In general, lower compression set values are desirable for elastomer compositions. This is the amount of the deflected distance that the compound did not return after heat aging. Inventive Example 3 shows that replacing 5 phr natural rubber with 5 phr of propylene-ethylene copolymer and slightly reducing the amount of oil, that the compression set is the same or slightly lower. Inventive Example 11 replaced all 10 phr of the natural rubber with 10 phr of propylene-ethylene copolymer along with oil reduction. In addition, 8 phr nanoclay were added along with a reduction of 12 phr carbon black. The resulting compression set was lower than the elastomer composition containing 10 phr natural rubber (Comparative Example 2).

TABLE 6

| COMPRESSION | | | |
|---|---|---|---|
| SET -METHOD B | Comp. 2 | Inventive 3 | Inventive 11 |
| Cure Time (min) | 18 | 18 | 22 |
| Cure Temperature (° C.) | 166 | 166 | 166 |
| Sample Type | solid | solid | solid |
| Deflection (%) | 25 | 25 | 25 |
| Ageing Time (hrs) | 70 | 70 | 70 |
| Ageing Temperature (° C.) | 125 | 125 | 125 |
| Ageing Type | air oven | air oven | air oven |
| Ageing Medium | hot air | hot air | hot air |
| Compression Set (%) | 76.61 | 76.48 | 73.24 |

### Example 7

This example is specific to tire inner liners. More specifically, this example relates to the adhesion of a tire inner liner formulation to a natural rubber carcass of a tubeless tire. This example shows that the adhesion of a 100 phr brominated isobutylene/isoprene rubber control compound (Comparative Example 1) is less than that of a 90 phr brominated isobutylene/isoprene rubber/10 phr natural rubber control composition (Comparative Example 2). It also shows that adhesion can be further increased by replacing 5 phr natural rubber with 5 phr of an propylene polymer (Inventive Example 1), while slightly reducing the oil content. Inventive Example 8 shows that removing the natural rubber completely and replacing with 6 phr propylene polymer and 4 phr propylene-ethylene copolymer and further reducing oil content yields a higher adhesive strength than the compositions that contain no propylene polymer, propylene copolymer, or combinations thereof.

TABLE 7

| RUBBER | | | | |
|---|---|---|---|---|
| ADHESION | Comp. 1 | Comp. 2 | Inventive 1 | Inventive 8 |
| Pirelli Laminated | | | | |
| Test Temperature | 100 | 100 | 100 | 100 |
| (° C.) | | | | |
| Adhesive Strength | 5.497 | 8.067 | 9.560 | 8.536 |
| (kNm) | | | | |

### Example 8

This example relates to aged adhesive values for a tire inner liner composition to a natural rubber carcass of a tubeless tire. The data show that replacing 5 phr natural rubber with 5 phr of propylene polymer (Inventive Example 1) or propylene-ethylene copolymer (Inventive Example 2) along with a slightly reduced oil content yields improved aged adhesive strength.

TABLE 8

| RUBBER ADHESION | Comp. 2 | Inventive 1 | Inventive 2 |
|---|---|---|---|
| Cure Time (min) | 18 | 17 | 17 |
| Cure Temperature (° C.) | 166 | 166 | 166 |
| Test Temperature (° C.) | 100 | 100 | 100 |
| Ageing Time (hrs) | 168 | 168 | 168 |
| Ageing Temperature (° C.) | 121 | 121 | 121 |
| Ageing Type | oven | oven | oven |
| Ageing Medium | hot air | hot air | hot air |
| Aged Adhesive Strength (kN/m) | 3.894 | 4.364 | 4.293 |

### Example 9

This example relates to the air permeability of elastomer compositions. This is of particular interest in applications where butyl rubber compounds are used to retain air, such as tire inner liners for tubeless tires, tire inner tubes and ball bladders.

TABLE 9

| PERMEABILITY TO GASES | Comp. 1 | Comp. 2 | Inventive 1 | Inventive 4 | Inventive 5 | Inventive 8 |
|---|---|---|---|---|---|---|
| Cure Temperature (° C.) | 166 | 166 | 166 | 166 | 166 | 166 |
| Specimen | perm | perm | perm | perm | perm | perm |
| Conditioning Time (hrs) | 16 | 16 | 16 | 16 | 16 | 16 |
| Conditioning Temperature (° C.) | 23 | 23 | 23 | 23 | 23 | 23 |
| Test Gas | air | air | air | air | air | air |
| Test Temperature (° C.) | 65.5 | 65.5 | 65.5 | 65.5 | 65.5 | 65.5 |
| Test Pressure (psig) | 50 | 50 | 50 | 50 | 50 | 50 |
| Permeability (cm²/(atm sec)) | 3.30E−08 | 4.30E−08 | 3.60E−08 | 3.20E−08 | 3.20E−08 | 2.90E−08 |

These results show that replacing part or all of the natural rubber in the control formulation (Comparative Example 2) with propylene polymer, propylene copolymer or combinations thereof (Inventive Examples 1, 4, 5, and 8), the air permeability values can be reduced. Inventive Examples 4, 5, and 8 show that by replacing all of the natural rubber with 10 phr propylene polymer, propylene copolymer or combinations thereof yielded similar or lower air permeability values when compared to the 100 phr brominated isobutylene/isoprene rubber control formulation (Comparative Example 1).

### Example 10

These results show that by replacing 5 phr natural rubber in the elastomer composition formulations with 5 phr propylene polymer, propylene copolymer or combinations thereof (Inventive Examples 1 and 2), the resistance to crack growth can be improved in the aged Demattia Flex Test. Example 7 showed that you can replace 10 phr natural rubber with 10 phr propylene copolymer and decrease crack growth resistance. All compositions containing propylene polymer, propylene copolymer or combinations thereof in this example passed greater than 250,000 cycles without crack growth, both initially and after aging 168 hours at 120 deg. C.

TABLE 10

| DEMATTIA FLEX TEST | Comp. 2 | Inventive 1 | Inventive 2 | Inventive 7 |
|---|---|---|---|---|
| Cure Time (min) | 18 | 17 | 17 | 21 |
| Cure Temperature (° C.) | 166 | 166 | 166 | 166 |
| Punched | Y | Y | Y | Y |
| Ageing Time (hrs) | 168 | 168 | 168 | 168 |
| Ageing Temperature (° C.) | 120 | 120 | 120 | 120 |
| Ageing Type | oven | oven | oven | oven |
| Ageing Medium | hot air | hot air | hot air | hot air |
| Punched Aged | yes | yes | yes | yes |
| Crack Growth Aged 300% (Kc) | 179.167 | >250 | >250 | >250 |
| Crack Growth Aged 600% (Kc) | >250 | >250 | >250 | >250 |

### Example 11

This example relates to the processing of the elastomer compositions on a 1602 gram Banbury Mixer with temperatures set at 30° C., a ram pressure of 30 psig, and a rotor speed of 77 rpm for a total mix time of 5 minutes. The rubber compound or rubber compounds were mixed for 30 seconds, then the additional ingredients were added. After 3.5 minutes, the ram was raised to conduct a “sweep”, where the carbon black was swept off the ram arm and upper part of the mixer. The ram was then lowered and mixing resumed. After 5 minutes, the elastomer composition was removed from the Banbury Mixer, and the drop temperature of the elastomer composition was recorded.

TABLE 11

| Processability | | | | | |
|---|---|---|---|---|---|
| BANBURY MIXING (300 SEC.) | Comp. 2 | Inventive 1 | Inventive 3 | Inventive 6 | Inventive 9 |
| Ave. kW/sec. for Banbury | 8.471 | 8.139 | 8.223 | 7.610 | 8.407 |
| Energy Reduction | | 3.9% | 2.9% | 10.2% | 0.8% |
| Drop Temperature (° C.) | 109.9 | 108.5 | 107.7 | 107.9 | 104.5 |
| Temperature Reduction | | 1.3% | 2.0% | 1.8% | 4.9% |

The energy required to turn both Banbury rotors for 300 seconds was recorded, and the average kW/sec. is shown in the Table 11 for the elastomer compositions. The data indicate that elastomer compositions containing 5 phr and 10 phr propylene polymer, propylene copolymer or combinations thereof (Inventive Examples 1, 3, 6, and 9) required less energy to mix. The energy reduction ranged from approximately 1% to 10%.

The drop temperature of the control compound containing 10 phr natural rubber (Comparative Example 2) was 109.9° C. The elastomer compositions containing 5 phr and 10 phr propylene polymer, propylene copolymer or combinations thereof (Inventive Examples 1, 3, 6, and 9), had lower drop temperatures. The reduction in drop temperature ranged from approximately 1% to 5%.

### Example 12

This example compares the Mooney Viscosity data of selected elastomer compositions. The Shore A2 Hardness results are included in this example for reference. The brominated isobutylene/isoprene rubber control composition (Comparative Example 1) and brominated isobutylene/isoprene rubber containing 10 phr natural rubber (Comparative Example 2) both had a Shore A2 Hardness of 51, while the elastomer compositions containing 5 phr and 10 phr propylene polymer, propylene copolymer or combinations thereof (Inventive Examples 1, 5, and 8) had Shore A2 Hardness values within one unit of the controls.

TABLE 12

| COMPOUND MOONEY VISCOSITY | Comp. 1 | Comp. 2 | Inventive 1 | Inventive 5 | Inventive 8 |
|---|---|---|---|---|---|
| Rotor Size | large | large | large | large | large |
| Test Temperature (° C.) | 100 | 100 | 100 | 100 | 100 |
| Preheat Time (min) | 1 | 1 | 1 | 1 | 1 |
| Run Time (min) | 4 | 4 | 4 | 4 | 4 |
| Mooney Viscosity (MU) | 56.45 | 55.48 | 54.43 | 53.00 | 54.17 |
| Hardness Shore A2 (pts.) | 51 | 51 | 52 | 52 | 50 |

The data show that the elastomer compositions containing 5 phr and 10 phr propylene polymer, propylene copolymer or combinations thereof (Inventive Examples 1, 5, and 8) have lower Mooney Viscosity values than the control compounds (Comparative Examples 1 and 2). The Moonie Viscosity of the inventive elastomer compositions containing 5 phr and 10 phr propylene polymer, propylene copolymer or combinations thereof are about 2% to 6% lower in viscosity than the Comparative Examples. It is generally believed that compounds with lower Mooney Viscosity values are easier to calendar and mold.

### Example 13

This example discusses the Moving Die Rheometer (MDR) test results. Ts 2 is commonly referred to as “scorch time”. Longer scorch times are generally better. Longer scorch times reduce the chance of beginning vulcanization too early in the process. The scorch time for the control compound containing 10 phr natural rubber (Comparative Example 2) is longer than the control compound containing 100 phr brominated isobutylene/isoprene rubber (Comparative Example 2). Elastomer compositions containing 5 phr and 10 phr propylene polymer, propylene copolymer or combinations thereof ( ) have longer scorch times than either of the control compositions.

TABLE 13

| MDR CURE CHARACTERISTICS | Comp. 1 | Comp. 2 | Inventive 1 | Inventive 2 | Inventive 7 | Inventive 9 |
|---|---|---|---|---|---|---|
| Frequency (Hz) | 1.7 | 1.7 | 1.7 | 1.7 | 1.7 | 1.7 |
| Test Temperature (° C.) | 166 | 166 | 166 | 166 | 166 | 166 |
| Degree Arc (°) | 1 | 1 | 1 | 1 | 1 | 1 |
| Test Duration (min) | 30 | 30 | 30 | 30 | 30 | 30 |
| Torque Range (dN · m) | 100 | 100 | 100 | 100 | 100 | 100 |
| Ts 2 (min) | 2.28 | 2.37 | 2.40 | 2.40 | 2.43 | 2.46 |
| T′ 95 (min) | 11.28 | 8.46 | 7.24 | 7.27 | 10.99 | 11.03 |

T′95 is generally accepted as the time where the elastomer composition is considered 95% vulcanized. In general, the less time it takes to vulcanize the elastomer composition the better. Elastomer compositions containing 5 phr propylene polymer, propylene copolymer or combinations thereof (Inventive Examples 1 and 2) had lower T′95 values than either of the control compositions (Comparative Examples 1 and 2). The elastomer compositions containing 10 phr propylene polymer, propylene copolymer or combinations thereof (Inventive Examples 7 and 9) have lower T′95 values than the 100 phr brominated isobutylene/isoprene rubber control (Comparative Example 1).

### Example 14

This example shows the GABO Dynamic Performance of the elastomer compositions. A temperature sweep was conducted at a frequency of 10 Hz under relatively low strain. Under these conditions, Tan Delta at 0° C. can be used to predict the wet traction of a tire. The higher the Tan Delta at 0° C., the better the predicted wet traction will be. This example shows that initial Tan Delta values at 0° C. for elastomer compositions containing 5 phr and 10 phr propylene polymer, propylene copolymer or combinations thereof (Inventive Examples 2, 6, and 8) are higher than that of the control composition containing 90 phr brominated isobutylene/isoprene rubber and 10 phr natural rubber (Comparative Example 2). This example also shows that the elastomer compositions containing 5 phr and 10 phr propylene polymer, propylene copolymer or combinations thereof have less of a change in aged Tan Delta values than the control compositions, particularly the elastomer compositions containing 10 phr propylene polymer, propylene copolymer or combinations thereof (Inventive Examples 6 and 8).

TABLE 14

| GABO Dynamic Performance @10 Hz | Comp. 2 | Inventive 2 | Inventive 6 | Inventive 8 |
|---|---|---|---|---|
| Cure Time (min) | 13 | 12 | 15 | 18 |
| Cure Temperature (° C.) | 166 | 166 | 166 | 166 |
| Initial Temperature (° C.) | −100 | −100 | −100 | −100 |
| Final Temperature (° C.) | 150 | 150 | 150 | 150 |
| Initial Tan Delta @ 0° C. | 0.5088 | 0.5562 | 0.5507 | 0.5569 |
| Ageing Temperature (° C.) | 120 | 120 | 120 | 120 |
| Ageing Time (hrs) | 168 | 168 | 168 | 168 |
| Ageing Medium | hot air | hot air | hot air | hot air |
| Aged Tan Delta @ 0° C. | 0.3502 | 0.4235 | 0.52 | 0.5455 |
| Tan Delta Change | −31.2% | −23.9% | −5.6% | −2.0% |

### Example 15

This example also shows the GABO Dynamic Performance of the elastomer compositions. This temperature sweep was conducted at a frequency of 10 Hz under relatively low strain. Under these conditions, Tan Delta at 60° C. can be used to predict rolling resistance of a tire. The lower the Tan Delta at 60° C., the lower the predicted rolling resistance. This example shows that initial Tan Delta values at 60° C. for elastomer compositions containing 5 phr and 10 phr propylene polymer, propylene copolymer or combinations thereof (Inventive Examples 2, 8 and 9) are similar to that of the control composition containing 90 phr brominated isobutylene/isoprene rubber and 10 phr natural rubber (Comparative Example 2). This example also shows that the elastomer compositions containing 5 phr and 10 phr propylene polymer, propylene copolymer or combinations thereof have less of a change in aged Tan Delta values than the control composition, particularly the elastomer compositions containing 10 phr propylene polymer, propylene copolymer or combinations thereof (Examples 8 and 9).

TABLE 15

| GABO Dynamic Performance @10 Hz | Comp. 2 | Inventive 2 | Inventive 8 | Inventive 9 |
|---|---|---|---|---|
| Cure Time (min) | 13 | 12 | 15 | 18 |
| Cure Temperature (° C.) | 166 | 166 | 166 | 166 |
| Initial Temperature (° C.) | −100 | −100 | −100 | −100 |
| Final Temperature (° C.) | 150 | 150 | 150 | 150 |
| Initial Tan Delta @ 60° C. | 0.193 | 0.1977 | 0.1941 | 0.1838 |
| Ageing Temperature (° C.) | 120 | 120 | 120 | 120 |
| Ageing Time (hrs) | 168 | 168 | 168 | 168 |
| Ageing Medium | hot air | hot air | hot air | hot air |
| Aged Tan Delta @ 60° C. | 0.1338 | 0.14 | 0.1503 | 0.1507 |
| Tan Delta Change | −30.7% | −29.2% | −22.6% | −18.0% |

That which is claimed is:

1. A curable elastomeric composition comprising at least one elastomeric polymer, at least one propylene polymer, and at least one curing agent.

2. The curable elastomeric composition according to claim 1 wherein said elastomeric polymer is produced from a polymerization reaction of at least one monoolefin monomer and at least one multiolefin monomer.

3. The curable elastomeric composition according to claim 2 wherein said monoolefin is a C₄ to C₇ isoolefin.

4. The curable elastomeric composition of claim 3 wherein said C₄ to C₇ monolefin is at least one selected from the group consisting of isobutylene, 2-methyl-1-butene, 3-methyl-1-butene, 2-methyl-2-butene, 4-methyl-1-pentene, and mixtures thereof.

5. The curable elastomeric composition according to claim 1 wherein said multiolefin monomer is at least one selected from the group consisting of isoprene, butadiene, 2-methylbutadiene, 2,4-dimethylbutadiene, piperyline, 3-methyl-1,3-pentadiene, 2,4-hexadiene, 2-neopentylbutadiene, 2-methyl-1,5-hexadiene, 2,5-dimethyl-2,4-hexadiene, 2-methyl-1,4-pentadiene, 2-methyl-1,6-heptadiene, cyclopentadiene, methylcyclopentadiene, cyclohexadiene, and 1-vinyl-cyclohexadiene.

6. The curable elastomeric composition according to claim 1 wherein said elastomeric polymer is at least one selected from the group consisting of butyl rubber, halogenated butyl rubber, star-branched versions of these rubbers, and brominated isobutylene-co-para-methystyrene (BIMSM) and blends thereof.

7. The curable elastomeric composition according to claim 6 wherein said butyl rubber is produced from a polymerization reaction mixture having from about 70% to about 99.5% by weight of an isoolefin having about 4 to about 7 carbon atoms and about 30% to about 0.5% by weight of a conjugated multiolefin having from about 4 to about 14 carbon atoms.

8. The curable elastomeric composition of claim 6 wherein said butyl rubber has a number average molecular weight of about 25,000 to about 500,000.

9. The curable elastomeric composition of claim 8 wherein said butyl rubber has a number average molecular weight of from about 100,000 to about 250,000.

10. The curable elastomeric composition of claim 6 wherein said butyl rubber has a number average molecular weight ranging from about 5,000 to about 25,000.

11. The curable elastomeric composition according to claim 6 wherein said butyl rubber is produced by the polymerization reaction of isobutylene and isoprene.

12. The curable elastomeric composition according to claim 6 wherein said elastomeric polymer is halogenated.

13. The curable elastomeric composition according-to claim 1 wherein the amount of the elastomeric polymer in the curable elastomeric composition ranges from about 60 phr to about 100 phr.

14. The curable elastomeric composition according to claim 1 further comprising at least one other elastomeric material.

15. The curable elastomeric composition according to claim 14 wherein said other elastomeric material is at least one selected from the group consisting of natural rubber (NR), ethylene-propylene rubber (EPR), styrene-butadiene rubber (SBR), polybutylene rubber, and polychloroprene.

16. The curable elastomeric composition according to claim 1 further comprising at least one other polymer.

17. The curable elastomeric composition according to claim 16 wherein said other polymer is selected from the group consisting of isotactic polypropylene, low density polyethylene, styrene-isoprene-styrene block copolymers, and styrene-ethylene-butene-styrene (S-EB-S) block copolymers.

18. The curable elastomeric composition according to claim 1 wherein said propylene polymer is selected from the group consisting of propylene homopolymers, propylene copolymers, terpolymers, interpolymers, and mixtures thereof.

19. The curable elastomeric composition according to claim 18 wherein said propylene polymers have a Ring and Ball Softening Point between about 80° C. and about 160° C. according to ASTM E28.

20. The curable elastomeric composition according to claim 18 wherein said propylene polymers have a Brookfield Thermosel Viscosity between about 100 and about 100,000 centipoise (cP) at 190° C. according to ASTM D3236.

21. The curable elastomeric composition according to claim 18 wherein the glass transition temperature (Tg) is below 0° C. according to ASTM D3418.

22. The curable elastomeric composition according to claim 1 wherein said propylene polymer has a needle penetration range of about 5 to about 300 dmm, determined by ASTM D5 (test method modified to 23° C., instead of 25° C.).

23. The curable elastomeric composition according to claim 22 wherein said propylene polymer has a needle penetration range of from about 5 to about 100 determined by ASTM D5 (test method modified to 23° C., instead of 25° C.).

24. The curable elastomeric composition according to claim 1 wherein the amount of propylene polymers contained in the curable elastomeric composition ranges from about 1 to about 20 phr.

25. The curable elastomeric composition according to claim 1 wherein said curing agent is at least one selected from the group consisting of sulfur, sulfur-containing compounds, and non-sulfur containing compounds.

26. The curable elastomeric composition according to claim 25 wherein said non-sulfur containing compound is at least one selected from the group consisting of peroxides, metallic oxides, chlorinated quinones, and nitrobenzenes.

27. The curable elastomeric composition according to claim 1 wherein said curing agent is facilitated by the addition of at least one activator.

28. The curable elastomeric composition according to claim 27 wherein said activator is selected from the group consisting of metal oxides and fatty acids.

29. The curable elastomeric composition according to claim 1 wherein said curing agent is facilitated by the addition of at least one accelerator.

30. The curable elastomeric composition according to claim 29 wherein said accelerator is at least one selected from the group consisting of aldehyde amines, dithiocarbamates, guanidines, sulfenamides, thiazoles, thioureas, thiurams, and other specialty compounds.

31. The curable elastomeric composition according to claim 1 wherein the amount of said curing agent is that which is sufficient to give a cure of greater than 90% as shown by a 90% S Prime value utilizing a MDR test.

32. The curable elastomeric composition according to claim 1 wherein the amount of said curing agent ranges from 0.1 phr to about 25 phr.

33. The curable elastomeric composition according to claim 1 further comprising at least one tackifier resin.

34. The curable elastomeric composition according to claim 33 wherein said tackifier is at least one selected from the group consisting of aliphatic hydrocarbon resins, aromatic hydrocarbon resins, mixed aromatic/aliphatic hydrocarbon resins, phenolic resins, polyterpene resins, and rosin esters.

35. The curable elastomeric composition according to claim 33 wherein the amount of said tackifier contained in said curable elastomeric composition ranges from about 0 to about 20 phr.

36. A process to produce a curable elastomeric composition comprising contacting at least one elastomeric polymer, at least one propylene polymer, and at least one curing agent.

37. A process to produce a cured elastomeric composition comprising heating said curable elastomeric composition of claim 1 to produce a cured elastomeric composition; wherein said elastomeric polymer in said cured elastomeric composition is substantially cross-linked.

38. A cured elastomeric composition produced by the process of claim 37.

39. An article comprising said cured elastomeric composition of claim 38.
